(19) United States
(12) Patent Application Publication
(10) Pub. No.: US 2006/0294000 A1
(43) Pub. Date: Dec. 28, 2006

(54) System and Method for Sub-Sector Specific Investing

(76) Inventors: Peter Bassett, Weston, MA (US); Nader Golestaneh, Wellesley, MA (US)

Correspondence Address: Brian M. Dingman, Esq.;Mirick, O'Connell, DeMallie & Lougee, LLP, 1700 West Park Drive, Westborough, MA, 01581, US

(21) Appl. No.: 11/425,758

(22) Filed: Jun. 22, 2006

Related U.S. Application Data
(60) Provisional application No. 60/694,189, filed on Jun. 27, 2005.

(51) Int. Cl. G06Q 40/00

(52) U.S. Cl. 705/37

(57) ABSTRACT

A method for accomplishing sub-sector specific investing. A sector sub-class specific exchange traded fund (ETF) having a number of shares is created. The shares are offered for sale, and one or more of the shares are sold to one or more appropriate buyers.

### CROSS REFERENCE TO RELATED APPLICATION

This application claims priority of provisional patent application Ser. No. 60/694,189 filed on Jun. 27, 2005, the disclosure of which is incorporated herein by reference.

### FIELD OF THE INVENTION

This invention relates to a system and method for investing through exchange-traded funds (ETFs).

### BACKGROUND OF THE INVENTION

An ETF is an investing tool that is similar to stocks, except that the shares of a given ETF represent an index of stocks, other securities or other investments rather than a single company stock. Similar to mutual funds, ETFs provide an investor with various types of diversity within a single fund. However, ETFs provide the added benefit of lower expenses, greater transparency, better tax efficiency, and flexibility. For example, unlike mutual or index funds, whose shares may only be bought at the end of the day based on that day's closing price or net asset value as of 4:00 pm on any given day, ETF shares may be purchased intraday, at any time during the trading day, in the same way stocks are traded. Examples of ETFs are the Standard & Poor's Depository Receipt (SPDR), otherwise known as spider, that trades as a stock on the American Stock Exchange and is an index of, or otherwise represents, the S & P 500; Diamonds (DIA) that trades as a stock on the American Stock Exchange and is an index of, or otherwise represents, the thirty stocks in the Dow Jones Industrial Average; Cubes (QQQQ) that trades as a stock on the NASDAQ and is an index of, or otherwise represents, the NASDAQ 100.

However, ETFs, particularly real estate based ETFs, can be limiting because each such ETF is an index of multiple types of asset classes of real estate whose ratio and types within a single ETF is predetermined by the ETF sponsor's selected index. For those investors who seek to participate in a particular asset class or particular sub-market within a specific sector, the trading characteristics of an ETF are currently not available. For purposes of describing the invention, currently available broad or sector based ETFs are referred to herein as macro ETFs as opposed to the novel sub-sector ETFs of the invention referred to herein as micro ETFs.

### SUMMARY OF THE INVENTION

It is therefore a primary object of this invention to provide a system and method for providing micro ETFs that are differentiated by asset sub-class and/or by sub-market and/or by sub-sector.

This invention relates to a system and method for investing through exchange-traded finds (ETFs) and more specifically, in the preferred embodiment of the system and method, to investing through real estate sub-sectors or sub-classes (micro ETFs) that are classified using the appropriate asset class or sector terminology. For example, within the sector of real estate, asset classes may include, but are not limited to, industrial, retail, residential, and/or hospitality, and/or market and sub-market classes based on geographic regions in the United States or elsewhere, not previously available to investors through ETFs.

This invention features a method for offering micro ETFs comprising the steps of: providing a sector sub-class specific exchange traded find comprising a plurality of shares, offering the shares for sale, and selling one or more of the shares to one or more qualified buyers. The step of selling may comprise selling the shares at any time intraday. The sector sub-class specific exchange traded fund may further comprise a plurality of share classes, and the step of selling may further comprise selling a plurality of shares specific to one or more of the share classes.

### BRIEF DESCRIPTION OF THE DRAWINGS

Other objects, features and advantages of invention will occur to those skilled in the art from the following description of the preferred embodiments and the accompanying drawings, in which:

FIGS. 1A-E are schematic diagrams of a plurality of preferred embodiments of the micro ETFs of the system and method of the invention; and

FIG. 2 is a flow chart of the preferred embodiment of the methodology of the invention.

### DETAILED DESCRIPTION OF THE PREFERRED EMBODIMENTS

The invention features a system and method that provides investors with a means for investing in specific sub-sectors and sub-classes of assets such as real estate holdings using an ETF structure. Since the system and method of the invention are novel and there is not any known terminology that would adequately describe the invention in short form, the ETFs of the invention are referred to herein as “micro ETFs” for the purpose of describing, but not limiting, the invention.

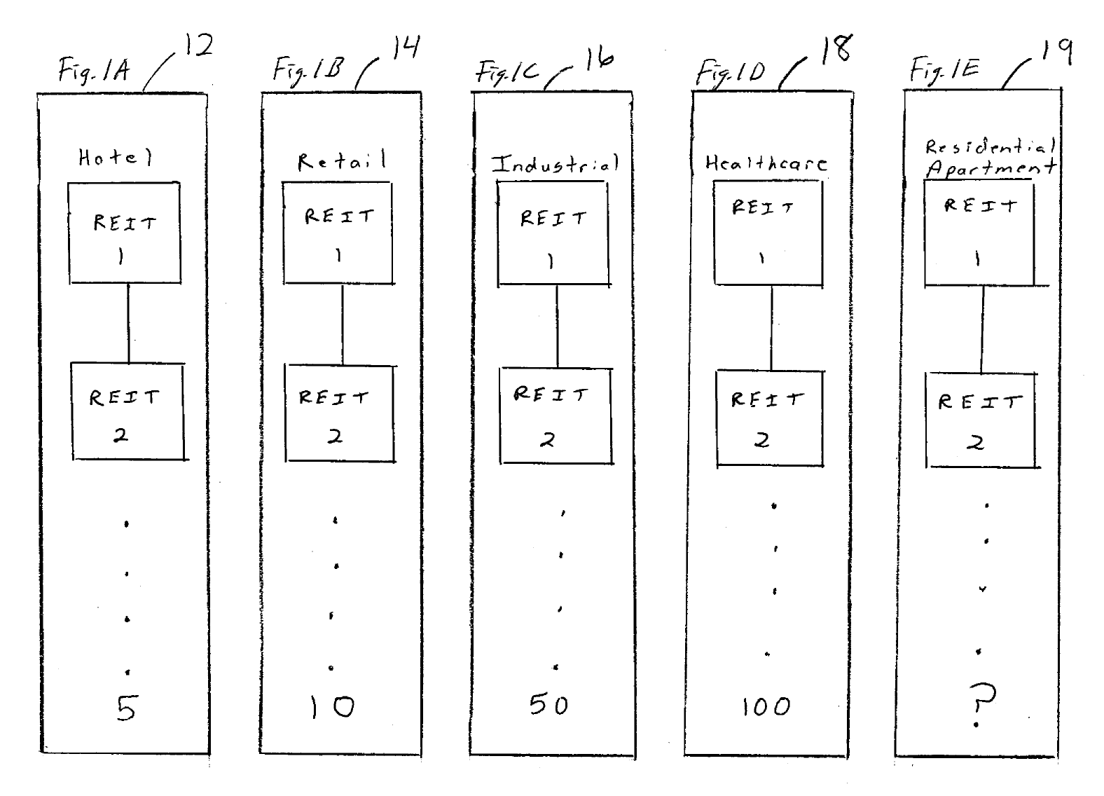

Schematic diagrams of a plurality of preferred embodiments of the micro ETFs, any one or more of which may be used in the system and method of the invention, are shown in FIGS. 1A-1E. Although the examples described are based on the real estate sector, the system and method of the invention may be modified for other potential sub-sectors or sub-classes of assets that are traded or could be traded and that can be further sub-classified. For example, the packaging industry is made up of non-competing businesses in the plastics packaging, paper packaging and glass packaging industries.

REITs commonly own and operate properties in a specific sub-sector of the real estate sector. Some such sub-sectors include residential, office buildings, shopping centers, regional malls, diversified, industrial facilities, mixed (industrial and office), health care, lodging/resorts, mortgage, specialty, and self storage.

As shown in FIG. 1, each of the micro ETFs of the invention comprise, for example, a plurality of real estate investment trusts (REITs) that are invested in a single sub-sector. For example, micro ETF 12 (FIG. 1A) comprises lodging/resort sub-sector REITs; micro ETF 14 (FIG. 1B) comprises retail sub-sector REITs; micro ETF 16 (FIG. 1C) comprises industrial sub-sector REITs, micro ETF 18 (FIG. 1D) comprises healthcare sub-sector REITs, and micro ETF 19 (FIG. 1E) comprises residential sub-sector REITs. Any one of these micro ETFs can be further structured based on any number of sector and/or sub-sector relevant variables such as capitalization, geographic region, and/or asset quality. The variables and combinations are virtually limitless. For example, micro ETF 12 comprises the top 5, micro ETF comprises the top 10, micro ETF comprises the top 50, and micro ETF 18 comprises the top 100, based on capitalization. Micro ETF 19 represents an undefined group that could be based on any one or more variables, such as geographic location within the residential apartment sub-sector

As of May 30, 2005, according to Thomson Financial Services, there exist a total of twenty-one exchange-traded funds (ETFs) available in the marketplace that comprise real estate equities. Eighteen are listed as closed-end funds and four are listed as index funds. Each of these ETFs represents a diversified mix of shares in REITs which themselves are unique products in the public markets. Most REITs specialize in investing in one type or specialized sub-sector of the vast real estate industry: residential, industrial, warehouse/manufacturing, lodging/resorts, retail regional malls, retail strip centers, self-storage, and health care, for example. A minority of REITs are diversified by property type. All of the REIT based ETFs hold a diversified mix of REITs—none holds a portfolio of REITs based on one sector, sub-sector, or sub-class of the real estate industry.

The largest current closed-end REIT ETF is ING Clarion Global Real Estate Income Fund with $2.5 billion under management. The smallest is AEW Real Estate Income Fund with $105 million. Similarly, the largest index REIT ETF is iShares Cohen & Steers Realty Majors Fund at $1.1 billion and the smallest index REIT ETF is Vanguard REIT VIPERS with $144 million.

As indicated, the real estate industry is segmented by asset class (aka sub-class) or sub-market. Institutional investors pay attention to the weighting of each asset class when they make investment or acquisition decisions. At the institutional ownership level, specialization in a particular asset class expresses expertise, and therefore permits the owner to use its expertise to its advantage.

Most real estate professionals' vocabulary and mindset are therefore based on their participation in a specific sub-class within the industry. A “hotel person,” “retail expert,” or “class A office developer” are ways these professionals identify with their product. This is reflected in the sector-specific holdings of the REITs themselves.

Over the last 10 years, the real estate sector has become an ever more accepted institutional investment, e.g. for pension funds of all descriptions from corporate to public sector. As a result many institutional investment portfolios have increased their real estate investment allocations from originally below 5% to over 15% of their total investment portfolio. Many institutional investors invest directly in real estate in segregated or “separate” accounts that hold title to the real estate in their name (thus direct investment) and managed by real estate professionals, or the institutional investors invest indirectly in real estate through ownership of REIT shares or by investing in co-mingled funds managed by pension fund advisors. The combination results in real estate as one of the largest portfolio allocations of institutional investors.

Investments in real estate by pension funds are often through co-mingled funds managed by pension fund advisors. These advisors further specialize in types (sub-classes) of investments, typically as to the quality of the asset: class A, B or C represents the quality of the location, building materials, size, marketability, etc. “Core,” “core plus,” or “value added” represent various relationships between risk and reward. Whatever asset class mix a pension fund advisor chooses to represent in this matrix, they prefer to specialize in that single asset class. Institutional investors view departures from these traditional specialized asset classes unfavorably because departures from the advisor's asset class specialty confuses the institutional investor's investment decision. This characterization is significant because the pension fund's portfolio manager reserves the right and obligation to diversify the risk of each class of real estate it may be holding. The system and method of the invention can accommodate such traditions. The micro ETFs of the invention may be divided into share classes to enable investors to purchase shares from any one of more of the offered subclasses. These share classes can be based on any number of variables, both traditional and new variables unique to micro ETF sub-classifications of the invention that will inevitably develop along with the demand for these micro ETF sub-classifications.

As noted, the system and method of the invention, when applied to the real estate market, provide the trading characteristics of an ETF that are currently not available to individual investors who seek to participate in sub-sectors or sector sub-classifications in the real estate markets. The system and method of the invention provide a novel means for sector sub-classification activities. If, for example, one felt that the hospitality industry is in recovery, one could purchase a lodging/resort ETF. Should a travel recession be imminent, one could short the lodging sector ETF. Real estate professionals could likewise balance their portfolios should their exposure in a certain area be unsuitable because, for example, they hold a large number of rather illiquid hotels as direct investments, and require a hedge in a suddenly down trending market.

Such sector ETF sub-classes can now become an essential part of many investment or trading strategies. Just as “industrials” are sectored in investment research departments and portfolio management departments by industry, e.g. paper and forest products, computing, pharmaceuticals, automotive, etc., real estate sectors will be available to these same investors as sub-classes, or micro ETFs, through the system and method of the invention.

A micro ETF of the invention can hold, for example, large numbers of REITs specializing in a single sector sub-class and, as such, becomes an analogue for that entire sector's sub-class. For example, a retail strip center-based micro ETF becomes the “market on strip centers”. Further, such large holdings will diversify such strip center REITs as to location, property management, tenant exposures, etc. and become a surrogate for all strip centers with which one could participate in or hedge against holdings in specific geographical markets or exposures to strips with common tenancies.

The system and method of the invention can be restructured and/or applied to all types of micro ETFs of the invention. For example, offerings using the invention can be structured as closed-end funds or indexes for any and all types of sectors and even more specifically to one or more types of groupings within a given sector. For further example, there are currently over 17 diversified REITs with market caps in excess of $25 billion, there are 12 health care REITs with caps over $14 billion, there are 24 office REITs with caps exceeding $56 billion, 15 industrial/mixed REITs with caps over $40 billion, 5 self-storage REITs with caps over $11 billion, 22 residential apartment REITs with capping over $46 billion, there are 24 shopping center/free standing retail REITs capping over $39 billion, 9 regional mall REITs capping over $47 billion, and 18 lodging/resort REITs capping over $16 billion. A given sector specific sub-class ETF of the invention could utilize a structure that includes a certain category within a particular sector such as ratio based groups, e.g. the five largest or 10 largest. The variables are innumerable and can be structured based on market demand. Depending on the structure or strategy desired, SEC requirements relating, for example, to the number of REITs in a larger pool of REITs must be followed. Alternatively, a given micro ETF of the invention could be indexed, or combined with logically related variables such as regional malls with strip center/free standing retail.

Many ETFs trade off of an index. The invention contemplates employing one or more existing indexes, and/or creating one or more indexes. One existing REIT index is the FTSE NAREIT US Real Estate Index Series. An example of an index that could be created for use in the invention would be a lodging index made up of REITs that own shares in the lodging real estate sub-sector. Examples of indexes for different asset sub-sectors for the invention could be an index created by an academic institution, an index designed by a commercial institution, or an index designed by a government agency.

The invention can also apply to indexes that include companies involved in non real estate-based sub-sectors and sub-classes. Examples of the almost limitless possibilities of sub-sectors or sub-classes of assets include: sub-sectors of the paper business, including Kraft paper, writing paper, tissue paper, linen or rag-based paper, etc; sub-classes of the software business, including virus protection, operating systems, productivity, internet-based, gaming, etc.; or sub-classes of the computer memory business, such as hard drives, RAM, ROM, flash, etc.

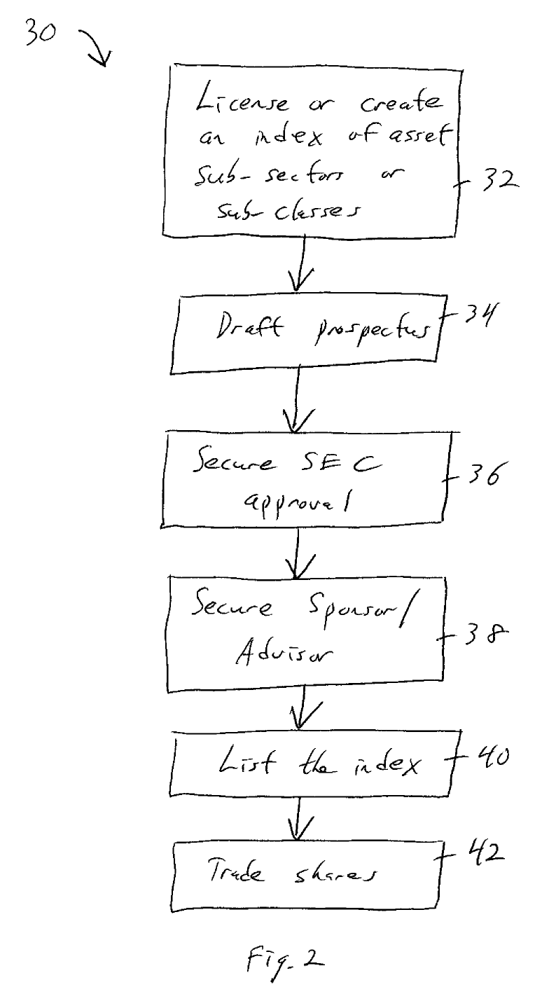

The steps taken to accomplish the methodology 30 of the preferred embodiment of the invention, FIG. 2, contemplate licensing or creating an appropriate index that includes sub-sector or sub-classes of assets, step 32, writing a prospectus based on the index parameters, step 34, securing exemptive approval from the SEC, step 36, securing an index sponsor and advisor, step 38, listing the index on an exchange, step 40, and then trading the ETF shares as done with any ETF, step 42. The micro ETFs of the invention can be structured for trading on any of the available exchanges. Depending on the exchange of choice, once the SEC or other jurisdictional authority approves a given micro ETF of the invention, the system can be run and managed through any of the known means available for trading securities.

Although specific features of the invention are shown in some drawings and not others, this is for convenience only as the features may be combined in other manners in accordance with the invention, which is defined only by the claims.

What is claimed is:

1. A method for accomplishing sub-sector specific investing comprising the steps of:
creating a sector sub-class specific exchange traded fund (ETF) comprising a plurality of shares;
offering the shares for sale; and
selling one or more of the shares to one or more appropriate buyers.

2. The method of claim 1 in which the step of selling comprises selling the shares at any time intraday.

3. The method of claim 1 in which the sector sub-class specific exchange traded fund further comprises a plurality of share classes.

4. The method of claim 3 in which the step of selling further comprise selling a plurality of shares specific to one or more of the share classes.

5. The method of claim 1 in which the step of creating an ETF comprises licensing an existing index.

5. The method of claim 1 in which the step of creating an ETF comprises creating an index.

6. The method of claim 1 in which the step of creating an ETF comprises creating a prospectus.

7. The method of claim 6 in which the step of creating an ETF further comprises securing SEC approval for the micro ETF.

8. The method of claim 7 in which the step of creating an ETF further comprises securing a sponsor for the micro ETF.

9. The method of claim 8 in which the step of creating an ETF further comprises securing an advisor for the micro ETF.

10. The method of claim 9 in which the step of offering the shares for sale comprises listing the shares of the micro ETF on an exchange.
